(19) United States
(12) Patent Application Publication
(10) Pub. No.: US 2010/0085748 A1
(43) Pub. Date: Apr. 8, 2010

(54) DISPLAY CASE LUMINAIRES

(76) Inventors: William Kelly, County Cork (IE); Paul O'Shaughnessy, County Galway (IE); John Bouchier, County Cavan (IE); Mark Walshe, Cork (IE); Thomas Hennessy, County Cork (IE); Desmond John O'Brien, County Cork (IE)

Correspondence Address: JACOBSON HOLMAN PLLC, 400 SEVENTH STREET N.W., SUITE 600, WASHINGTON, DC, 20004, US

(21) Appl. No.: 12/311,903

(22) PCT Filed: Oct. 18, 2007
(86) PCT No.: PCT/IE2007/000101

§ 371 Date: Apr. 17, 2009

(30) Foreign Application Priority Data
Oct. 19, 2006 (IE) 2006/0767
Jun. 26, 2007 (IE) 2007/0459

(51) Int. Cl. F21V 1/00

(52) U.S. Cl. 362/235

(57) ABSTRACT

A display case luminaire (30) comprises a linear housing, array (32) of LED light sources, and lens (33), wherein the lens provides a substantially uniform spread of light across a target plane even if the luminaire is located to emit light generally at an acute angle to the plane. The lens (33) is a Fresnel lens and has non-uniform optical characteristics in cross-section, with at least two different focal lengths. The linear housing comprises a visor (36) and a reflective surface (35) externally of the lens and a reflective surface (35) between the lens and the light source. A display case luminaire as claimed in any preceding claim, wherein the housing is configured for mounting back-to-back with another similar luminaire to provide a field of emission in the range of 150° to 180°. The housing is generally quadrant-shaped in cross-section, and the lens may be tilted with respect to the light source.

### FIELD OF THE INVENTION

The invention relates to luminaries or “luminaires”.

### PRIOR ART DISCUSSION

There is a difficulty in trying to obtain even illumination of a target plane, from a light source which is offset and placed to one side. FIG. 1 shows a light source S with a “viewing angle” Δθ, defined as the full width half maximum when flux intensity (I) is plotted versus emitted angle θ, as shown in FIG. 2. The light source S is shown with the beam centre making an angle α with the target plane P. Because the area subtended on the target plane P, per unit solid angle of emitted light becomes much greater as the distance from the source increases, the illuminated intensity pattern on the plane becomes quite asymmetric, with a strong peak on the side close to the source, and a rapid falloff with distance thereafter, as shown in FIG. 3 which plots I versus distance x.

The light sources can be a bulb, or LED sources. LED sources can be supplied either lensed, with typical viewing angles from 70 degrees down to a couple of degrees, or unlensed, with broader viewing angles ranging from 100 degrees to around 140 degrees.

FIGS. 4 and 5 show a prior arrangement to improve illuminated uniformity, which is to use two light sources, A and B, so that the resultant illumination pattern C has filled in the under-illuminated section in the middle of the target plane P. The result is generally still not satisfactory from the point of view of the uniformity of the illumination, with the intensity at C often less than 50% of that at A or at B as shown in FIG. 5.

An objective is to achieve improved uniformity of illumination for applications such as retail display cases or cabinets. Another objective is to achieve improved fixtures and fittings for mounting luminaires in display cases so as to enable them to function optimally. Yet another objective is to achieve improved control circuitry which will enhance the regulation of the electrical supply to the light sources in the luminaire, and enable the manufacturing of the luminaires to be less dependent upon the tolerances of the electrical characteristics of the light sources and power supplies which are used in the luminaire.

### SUMMARY OF THE INVENTION

According to the invention, there is provided a display case luminaire comprising a linear housing, an array of LED light sources, and a lens, wherein the lens provides a substantially uniform spread of light across a target plane even if the luminaire is located to emit light generally at an acute angle to the plane.

In one embodiment, the lens has non-uniform optical characteristics in cross-section, with at least two different focal lengths.

In one embodiment, the lens has optical characteristics which vary continuously across the cross-section of the lens.

In one embodiment, the lens has one or more discrete optical characteristic discontinuities.

In one embodiment, the lens is a Fresnel lens.

In one embodiment, the linear housing comprises a visor.

In one embodiment, the visor extends along the length of the linear housing.

In one embodiment, the luminaire further comprises a reflective surface externally of the lens and a reflective surface between the lens and the light source.

In one embodiment, said external surface is a surface of the visor.

In one embodiment, the housing is configured for mounting back-to-back with another similar luminaire to provide a field of emission in the range of 150° to 180°.

In one embodiment, in the housing is generally quadrant-shaped in cross-section.

In one embodiment, the lens is tilted with respect to the light source.

In one embodiment, the tilt angle is in the range of 10° to 15°.

In one embodiment, there are a plurality of elongate lenses interconnected by connectors.

In one embodiment, each connector is substantially H-shaped, having sockets for receiving the edges of lenses on each side.

In one embodiment, the housing comprises an end cap which is removable.

In one embodiment, the end cap comprises a mounting bracket having a through-hole for receiving a fastener securing the luminaire to a display case.

In one embodiment, the mounting bracket is in the form of a U-shaped support post having a folded-over key for engaging a fixed part of the end cap.

In one embodiment, the luminaire further comprises a clip-on mounting bracket having a pair of clip members for gripping opposed rear surfaces of the housing at any desired location along the housing length, the bracket having a through-hole for a fastener.

In one embodiment, the luminaire further comprises a thermally insulating member over at least part of the housing.

In one embodiment, the member is in the shape of a strip, and is secured to the luminaire housing along an edge of the housing.

In one embodiment, said member has an outer coating presenting a metallic appearance on the outside.

In one embodiment, the end cap comprises an electrical connector for connecting electrical leads to the circuit.

In one embodiment, the connector is a slip ring connector, the connection being maintained as the end cap is rotated to be secured in place on the housing.

In one embodiment, the connector is an axial connector, the connection being made as the end cap is pushed towards the housing.

In another aspect, the invention provides a display case luminaire assembly comprising a pair of luminaries of any preceding claim secured together in a back-to-back arrangement.

In one embodiment, the luminaries are secured together by at least one plate extending across the ends of the luminaries.

In a further aspect, the invention provides a display case comprising a frame, display shelves, and at least one luminaire as defined above secured to the frame or a shelf.

In one embodiment, the luminaire is vertically aligned.

In one embodiment, the luminaire is horizontally aligned under a shelf.

In one embodiment, the display case comprises end mullions, a luminaire on each end mullion, the luminaires being orientated for substantially uniform illuminating of a vertical plane including front edges of the display shelves.

In one embodiment, the case comprises a centre mullion and a pair of luminaires arranged back-to-back and secured to the centre mullion to provide a combined field of illumination in the range of 150° to 180° towards a vertical plane.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIGS. 1 to 5 illustrate prior art illumination scenarios referred to above;

FIGS. 6 to 8 are diagrams illustrating spreading of light with luminaires of the invention;

FIG. 9 is a perspective view of a Fresnel lens for a luminaire of the invention;

FIG. 10 is a plot illustrating performance of a luminaire of the invention;

FIG. 11 is a cross-sectional view of a luminaire, and FIG. 12 shows a pair of these luminaires back-to-back;

FIG. 13 is a plan view of a display cabinet having the luminaires of FIGS. 11 and 12;

FIGS. 14(a) and (b) are cross-sectional views of a single luminaire with different clip-on mounting brackets;

FIGS. 15(a) and (b) are cross-sectional views of a double luminaire assembly with different clip-on mounting brackets;

FIGS. 16 to 18 are perspective views of end cap mounting brackets;

FIG. 19 is a perspective view of a full luminaire with both a clip-on mounting bracket and an end cap mounting bracket;

FIG. 20 shows interconnection of Fresnel lenses in a luminaire;

FIG. 21 is a perspective view showing how a series of circuit boards are interconnected to form a full luminaire circuit;

FIGS. 22 is a cross-sectional view showing an luminaire connected to the end of a shelf and having a thermally insulating safety strip; and

FIG. 23 is a diagrammatic representation of an end cap arrangement for electrical connection.

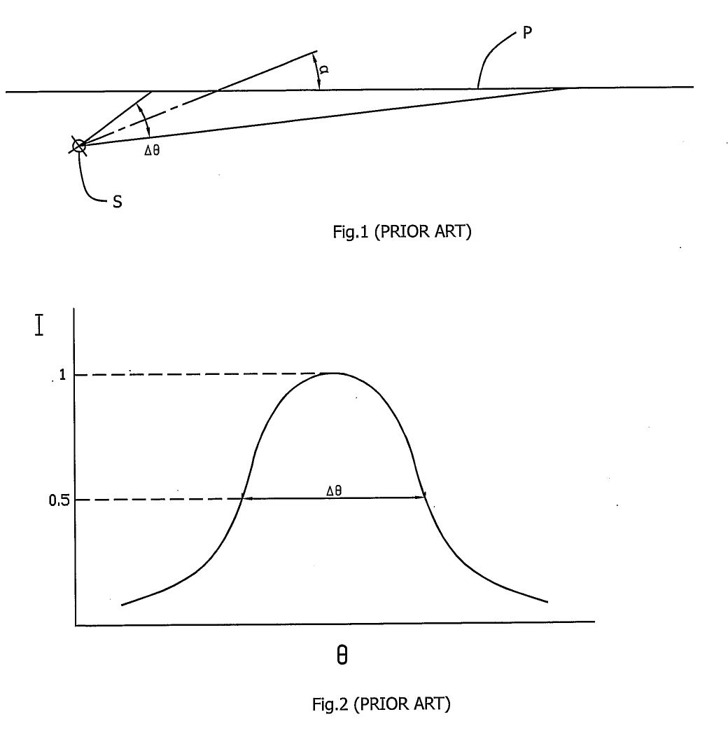

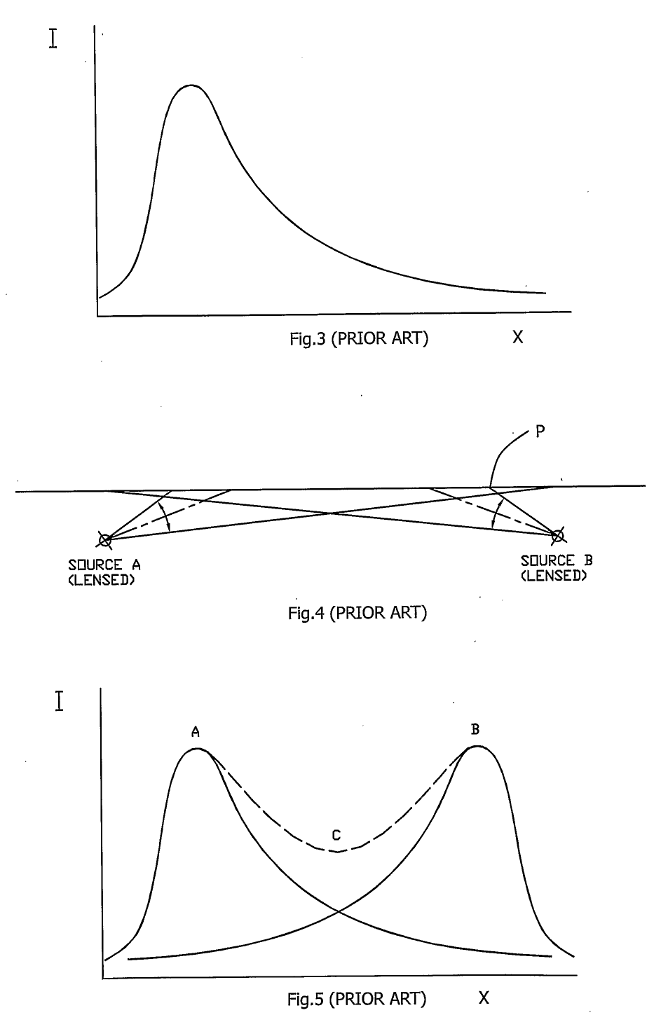

### DESCRIPTION OF THE EMBODIMENTS

The invention provides a luminaire having a lens with optical characteristics to redirect and refocus light from its source so as to maintain a substantially uniform illuminance across a target plane, so that the area illuminated by the same quantity of flux from the source remains constant. The invention also provides display cabinets incorporating such luminaries.

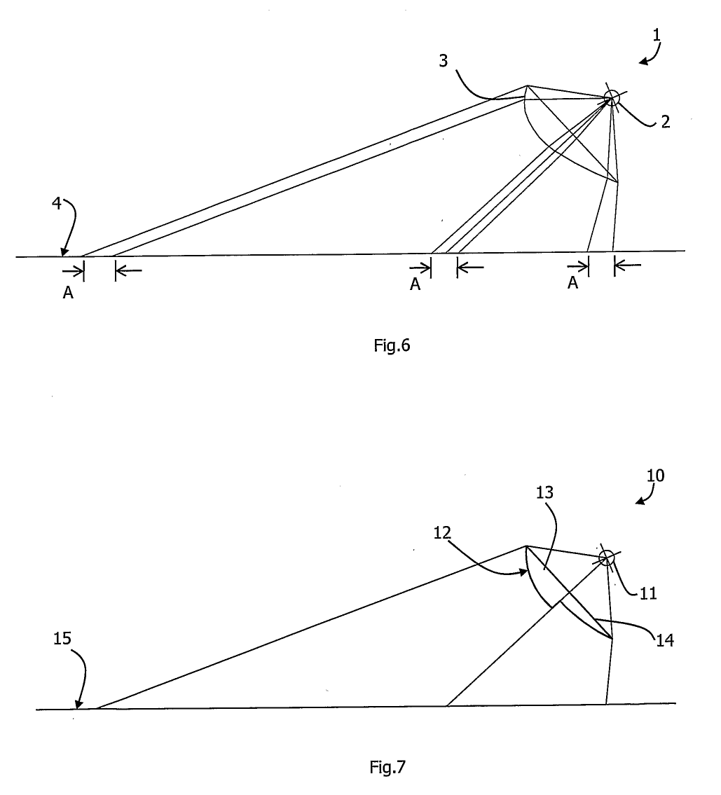

Referring to FIG. 6 a luminaire 1 having a linear series of LED sources 2 and a linear lens 3 is shown diagrammatically in cross-section. The lens 3 is moulded so that its optical characteristics, and most importantly focal length, vary continuously across the cross-section. This variation compensates for the fact that the luminaire is mounted at an acute angle to a target plane 4 as indicated by the lines indicating equal illumination intensity along the lengths “A”. There may be a product shelf of a cabinet in the plane 4, for example. Alternatively the target plane may be a vertical plane through the front edges of a series of shelves, one above the other.

Referring to FIG. 7 a luminaire 10 has a lens 12 with two halves 13 and 14, each half designed to produce a different refraction in the light emitted from a source 11, in this embodiment providing two discrete focal lengths. This improves the beam characteristics so as to more evenly illuminate a target plane 15.

The source may be an elongate array of unlensed LEDs, and the luminaire may be 1.5 m long, for example.

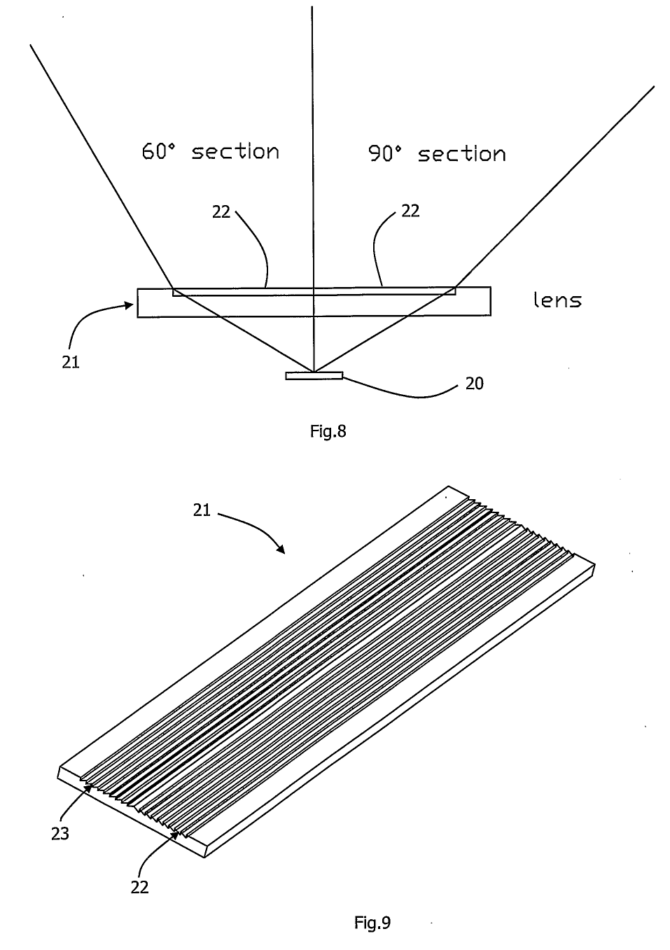

The lens may alternatively be a Fresnel lens, as shown in FIG. 8. FIG. 8 shows an LED array 20 emitting light through a lens 21 having a Fresnel surface. On one half, 22, of the surface the Fresnel grooved pattern is designed for a beam fwhm of 60 degrees, and on the other side, 23, the pattern is designed for a beam fwhm of 90 degrees. FIG. 9 is a perspective view of the lens 21. Most importantly, there is a different focal length at each side, achieving optically the same effect as illustrated in FIG. 6.

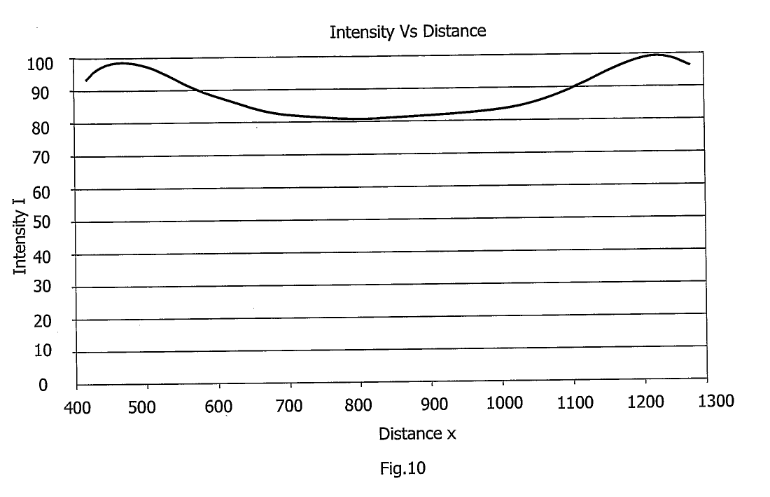

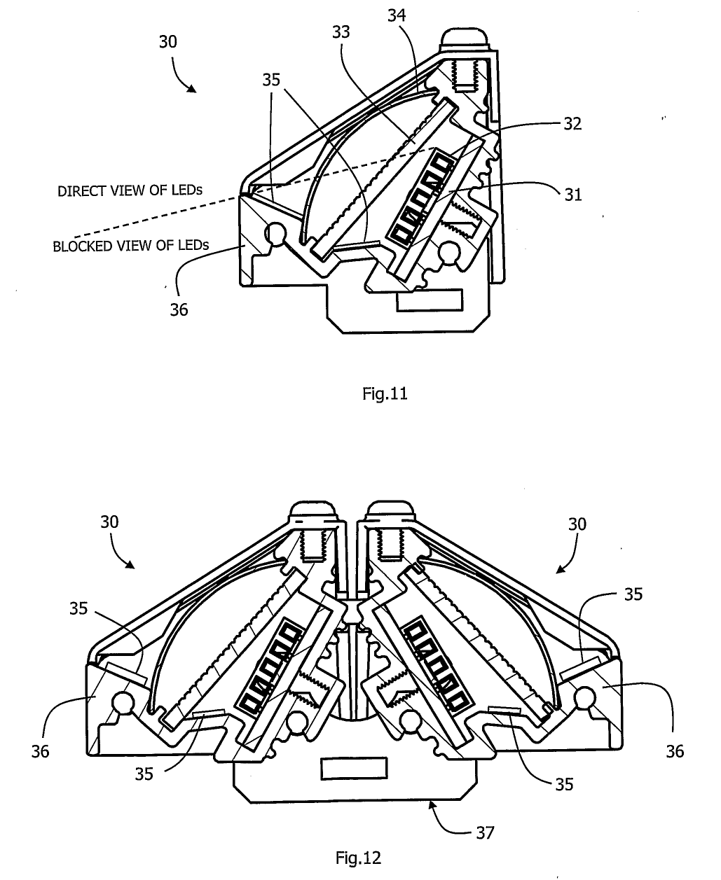

FIG. 10 shows the illumination obtained with a lens of FIGS. 8 and 9. Uniformity has been improved substantially from the prior art, being about +/−10% of the mean value across the entire active part of the target screen. In closer illumination environments such as the inside of a freezer, internally reflected light from the freezer walls will have the effect of improving the uniformity further.

Referring to FIG. 11 a linear luminaire 30 is shown in cross section. It has a PCB 31, LEDs 32, a Fresnel lens 33, a translucent cover 34 (which may also be a diffuser), internal and external planar reflective surfaces 35, and a visor 36. The housing also serves as a heatsink for the heat generated by the LEDs 32.

FIG. 12 shows a pair of the luminaires 30 back-to-back, held together by an end bracket 37.

The luminaire 30 has good uniformity as the lens (a) has the non-uniform optical characteristics of the lens 21 above, and (b) is tilted so that its back surface is no longer normal to the centre of the beam from the LED sources 32. There is a tilt angle of 12° in this embodiment. Each individual Fresnel facet of the lens 33 has a construction optimised in combination with the 12° tilt for the particular part of the target plane it is to illuminate so that there is a continuous progression in lens characteristics across the width of the lens. In addition to the lens, the luminaire has the reflective surfaces 35 to redirect some otherwise “lost” light into the darker areas of the illuminated surface. One of these reflective surfaces is external to the lens and cover. The other reflective surface is internal to the lens. The combination of internal and external reflectors is particularly advantageous because in this embodiment it has been found that the internal reflector provides a 4% increase in total light reaching the target plane, the external reflector a 6% increase. Both are positioned to re-direct light to the area of the target plane furthest from the luminaire, to improve illumination uniformity. It has been found that a combination of the internal and external reflectors, the bi-focal nature of the lens, and the tilted angle of the lens provides an improvement in uniformity from +/−35% of mean value to +/−10% of mean value.

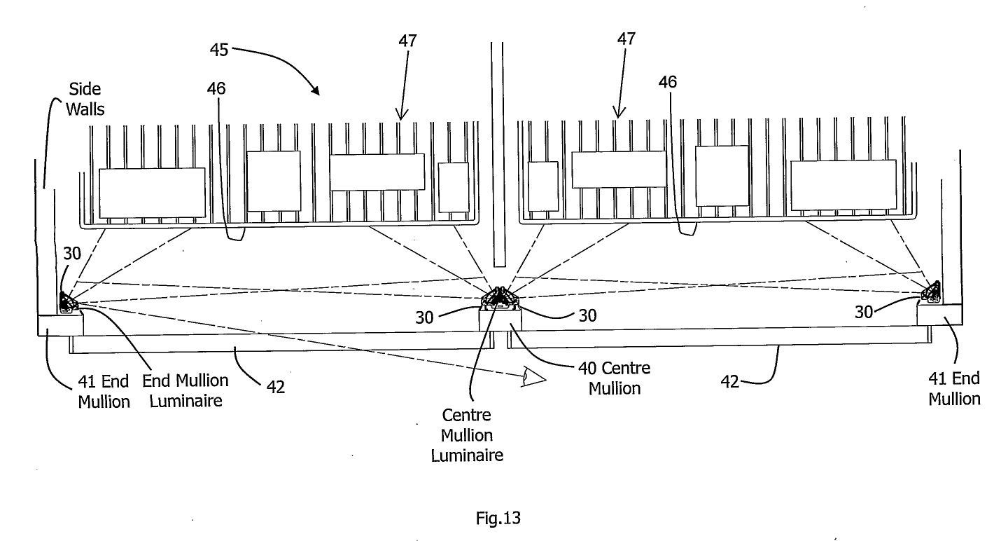

FIG. 13 shows a two-door freezer display case 45, and the locations of a centre-mullion 40 and end-mullions 41 supporting doors 42. In general, freezer cases can have up to five doors. The centre mullion 40 supports in vertical alignment two back-to-back luminaries 30, whereas the end mullions 41 each support a single luminaire 30. It will be apparent from this drawing that excellent distribution of light is achieved behind the doors 42, across a vertical plane 46 through the front edges of display shelves 47.

Referring again to FIG. 11, the visor 36 of the housing ensures that it is not possible for a customer walking along the aisles to view the LED sources directly, and be exposed to “glare”. This is a term often used when the customer has a direct view of the LED sources, or of the multiple internal reflections generated within the glass door by the LED sources.

The luminaires are “handed” in the sense that the cables are generally supplied from the top of the case, and for a left-hand end mullion 41, the light must be directed to the right, while for a right-hand end mullion 41, the light must be directed to the left (FIG. 13). For the centre mullion 40, light must be directed to both sides. The luminaires use the same extrusion shape for all units, and use end-caps to distinguish right from left.

FIG. 13 illustrates how the luminaires of the invention are very versatile, allowing uniform illumination across the vertical plane 46 despite the fact that space is very confined within the freezer cabinet. The description below also demonstrates how the luminaries may be easily retro-fitted to existing freezer display cases.

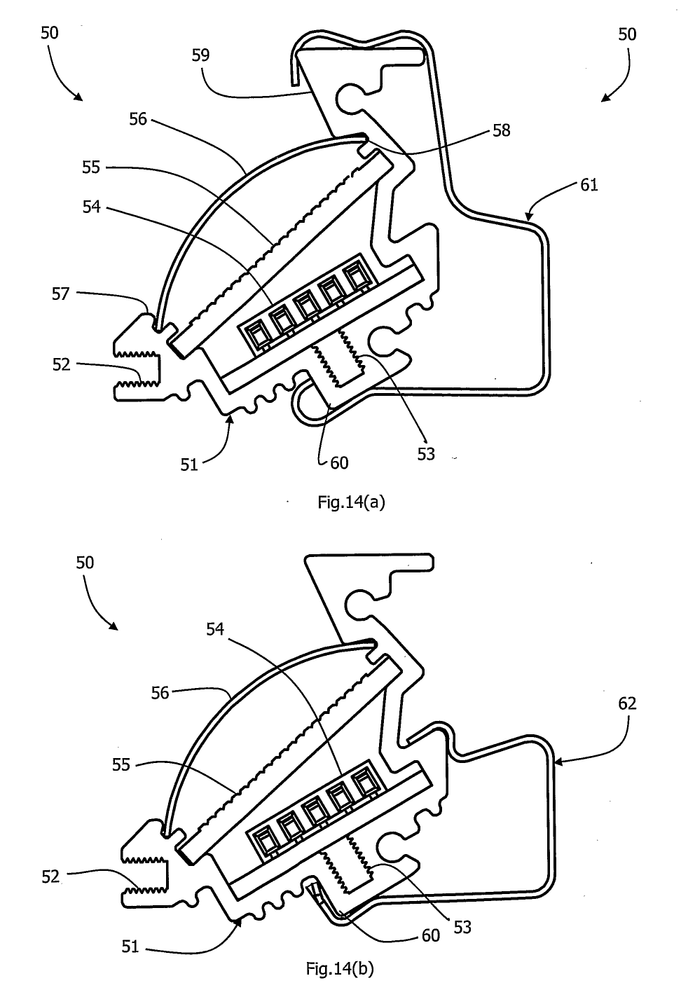

Referring to FIGS. 14(a) a luminaire 50 has an elongate housing 51, with a threaded hole 52 for an end cover and a threaded hole 53 for securing the circuit board in place for optimum heat transfer to the housing. There is a linear array of LEDs 54, a tilted non-uniform Fresnel lens 55, and a cover 56 retained between opposed elongate grooves 57 and 58. The housing 51 is shaped to include opposes surfaces 59 and 60. These act to allow a clip-on mounting bracket 61 to be clipped in place at any desired location along the length of the luminaire. The location is chosen in use as the most convenient to suit installation of the luminaire in the particular display cabinet. FIG. 14(b) shows the same luminaire, 50, with a different clip-on mounting bracket 62. The bracket 62 is clipped to a different pair of opposed surfaces of the back of the housing 51. It will be appreciated that various different configurations of clip-on bracket may be employed due to the fact that the housing presents different options for opposed surfaces. The configuration of bracket may be chosen according to available space in the cabinet and mechanical support requirements.

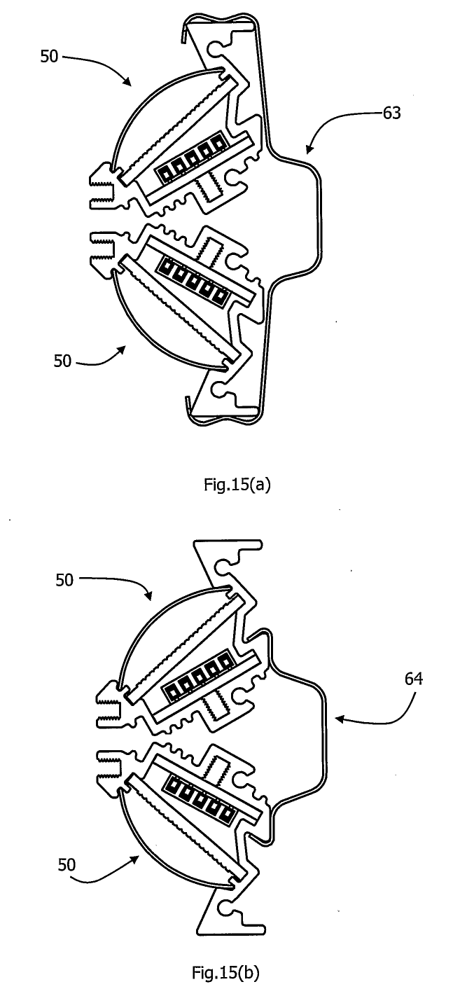

FIGS. 15(a) and (b) show brackets 63 and 64 respectively, each supporting a pair of luminaries 50 back-to-back. Each of these luminaire assemblies is suitable for use on a centre mullion as shown in FIG. 13, for example.

The clip-on brackets can be secured to the mullion of the case either with screws, with self-adhesive tape, with “hook-and-loop” fasteners, or with glue. Since the brackets can be positioned anywhere along the main body of the luminaire, this provides a flexible mounting technique, independent of fixed support points on the mullion or support surface.

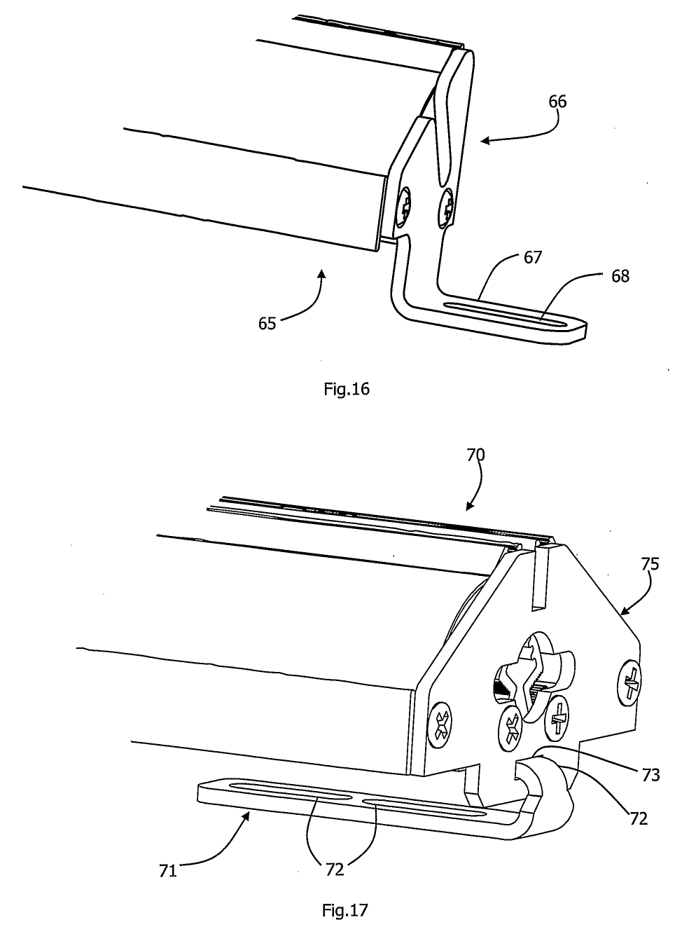

FIG. 16 shows a luminaire 65 having an end cap 66 with an end mounting bracket 67 having a slot 68. In this case, the slot 68 provides flexibility in mounting position, depending upon its length.

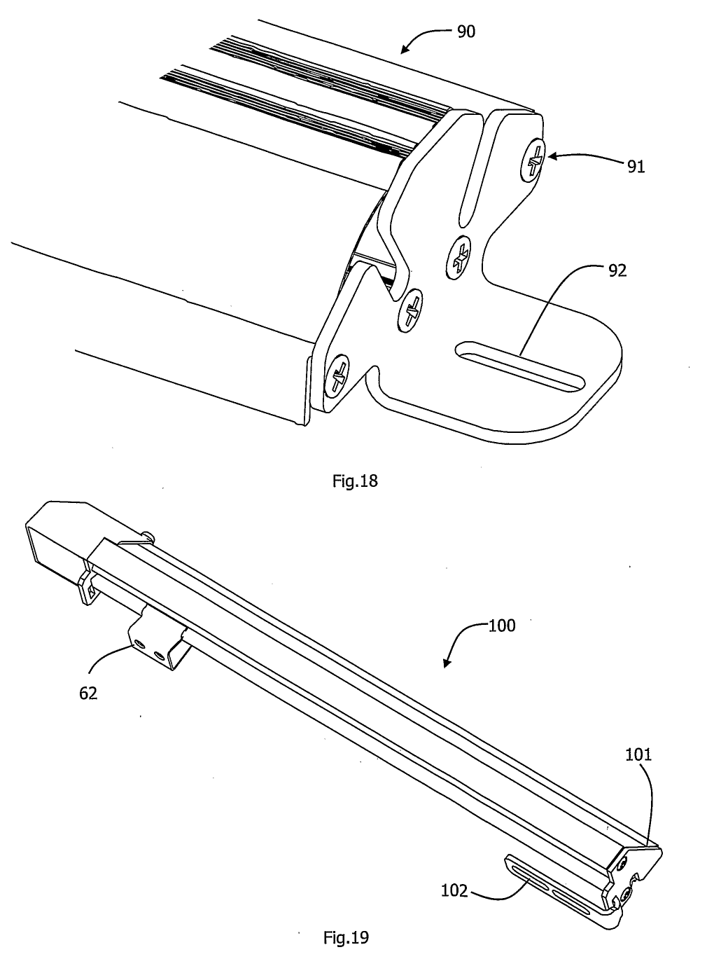

FIG. 17 shows a luminaire 70 having an end cap 75 to which is engaged with a support post 71 having screw slots 72. The slots 72 provide flexibility in locating the support post onto a mullion. The support post 71 has a key 72 which fits into a matching hole 73 in the end cap 75, and enables the luminaire assembly 70 to have a solid bottom locating point. The top of the luminaire can be held by any one of the clip-on brackets or end brackets. The support post 71 can be used to hang the luminaire from the top side with the clip-on bracket securing the lower side of the luminaire. Also, for horizontal mounting two clips are used. The end cap 75 secures two luminaries 30 in back-to-back relationship. The assembly may have covers over the end cap, possibly of plastics material. These prevent dust ingress and allow easy cleaning.

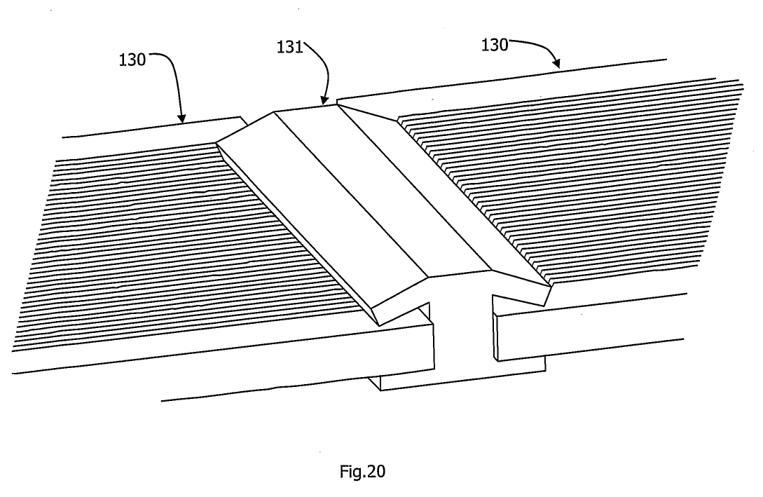

FIG. 18 shows a luminaire assembly 90 having a pair of luminaires 30 held together by an end cap 91 with a bracket having a screw slot 92. This slotted bracket enables a degree of flexibility in positioning of the assembly 90.

FIG. 19 shows a luminaire 100 fitted with a clip-on bracket 62, an end cap 101, and a support post 102. This may be installed in a display case by first screwing the end post 102 in a suitable position, and then correspondingly mounting the clip-on bracket 62. The key on the support post 102 is then inserted into the locating hole on the end cap, and the luminaire assembly pushed onto the spring clip until it is positively retained. This type of mounting arrangement is particularly useful for luminaires mounted vertically, the weight of the luminaire helping to retain the locating hole onto the support post.

The design of the mounting bracket hardware is such that it allows excellent flexibility during the retrofit process so as to allow the installer to complete the installation without the use of electrically or battery powered tools or the need to drill new holes in the mullion. This is achieved by the use of a mounting bracket that contains a vertical screw slot to accommodate previously drilled holes in the mullion during the original fluorescent lighting system installation. Through the use of such a bracket system at both the top, and/or, bottom, and/or along the length of the luminaire use can be made of pre-existing drilled holes for the illuminators being replaced, such as fluorescent illuminators. This avoids need to re-drill the mullion, and prevents damage to a mullion anti-sweat heating system or existing wiring. The luminaire design also takes into account the various differences in the width of mullion recesses so that the luminaire has a minimal protrusion into the air flow of the refrigerated air curtain and ensures maximum performance of the refrigeration system.

The end cover also has a function to conceal the wiring and the end bracket mounting screw. The end cover can be placed on one or both ends of the luminaire, offering the option to configure the luminaire to be wired from either or both ends. The electrical installation is also flexible, allowing use of the existing wiring harness in the display case framework.

Modularity with respect to length is very good for these luminaires. Each luminaire comprises a number of circuit board segments. When these are combined to make up the total length, since the extrusion is supplied in long lengths, it can be cut to suit, so almost any distance between mounting holes in the display case can be readily accommodated.

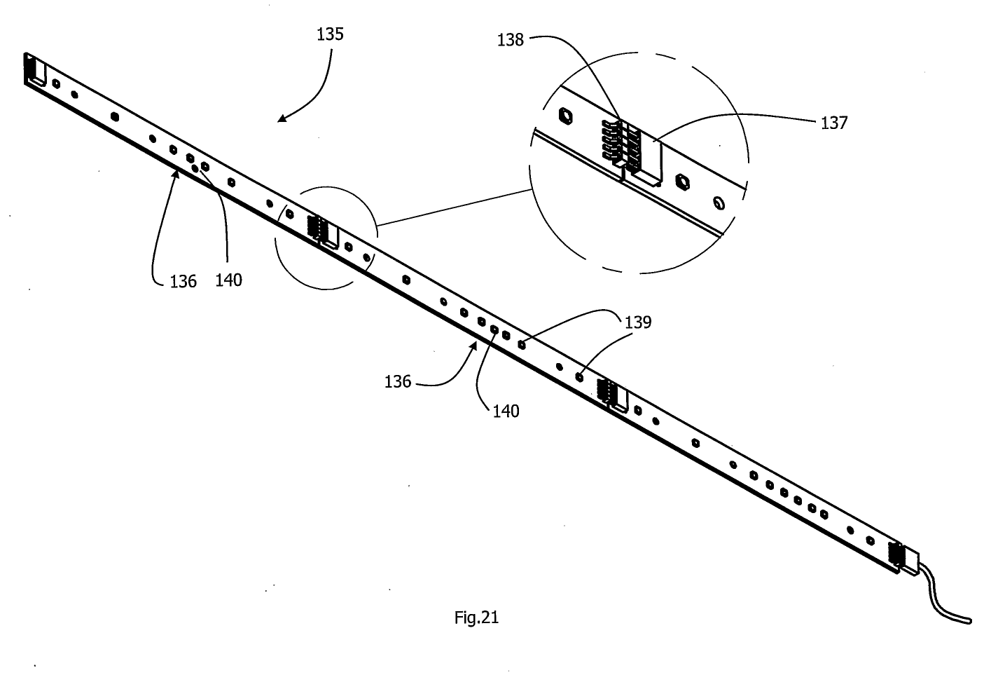

FIG. 20 shows a pair of Fresnel lens 130 interconnected by a generally H-shaped translucent flange 131. This allows excellent modularity. In another embodiment the lenses are simply abutted without use of a connector. FIG. 21 shows interconnection of the circuit boards into a full strip 135. The full circuit comprises a number of circuit board segments 136, interconnected by electrical connectors 137 and 138. LEDs 139 and drive circuit components 140 are also shown in this drawing.

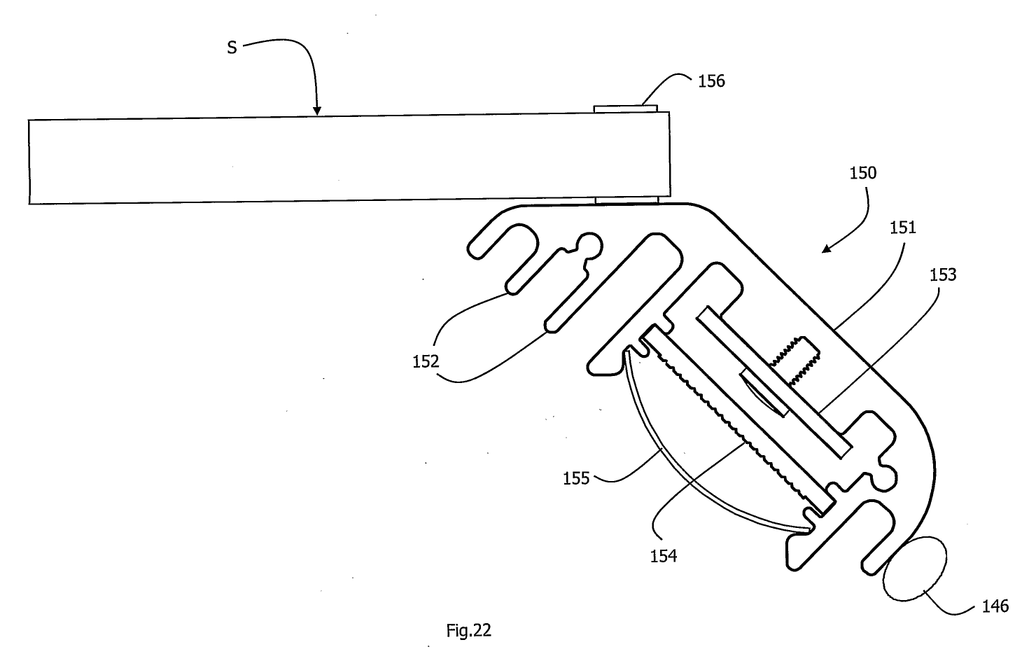

FIG. 22 shows a luminaire 150 having a housing 151, integral heat dissipation fins 152, a PCB with LEDs 153, a lens 154, and a cover 155. This embodiment illustrates that the luminaire of the invention is not necessarily secured to a mullion, in this embodiment being secured by a bracket 156 to the edge of a shelf S. An important aspect of the luminaire 150 is a thin, metallised but thermally insulating strip 146 in order to prevent accidental discomfort in the event of bare skin touching the heatsink surface, which under certain conditions in warm ambient environments can become warm enough to cause such discomfort. This trim 146 has a chrome-plated finish or other suitable finish that blends with the surface finish of the luminaire heat sink. The trim core material has a high thermal resistance as to act as a thermal shock absorber in the event that a person should touch the trim during the normal operation of the luminaire. The trim has a good thermally resistant adhesive strip with a broad working temperature range from −20° F. up to +150° F. The adhesive tape can be either acrylic based or a rubber based adhesive with good peel resistance and can be applied and cured under normal or elevated room temperature conditions.

An important figure of merit for a luminaire is its colour rendering index (CRI), which is a measure of how well the quality of the light compares with a standard illumination source such as an incandescent bulb. We can improve the colour rendering index (CRI) by tailoring the transmissivity of the lens, or the lens cover, in the luminaire so that the resulting output light is a better match to the reference source. This can be done by making the lens or cover from a “coloured” material, or by adding one or more thin surface layers so as to provide the necessary optical characteristics. In one embodiment there is a stop-band in the filter, so as to create a narrow valley, whose bottom is below the background noise. If this were symmetrically located on the opposite side of green (555 nm) from the usual 479 nm blue peak, the resulting symmetry would give a better CRI to the human eye, or a more pleasing result.

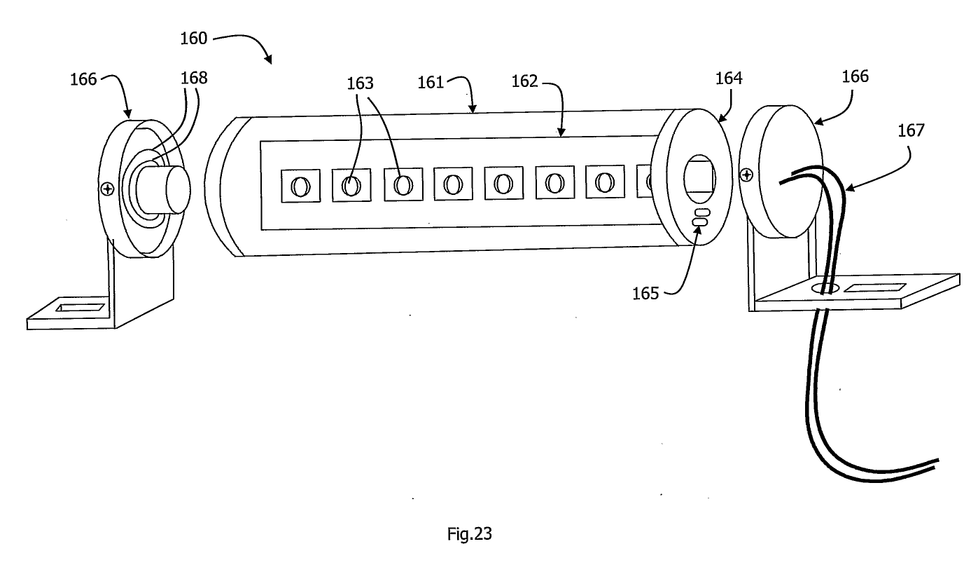

Referring to FIG. 23 a luminaire 160 has a housing 161, a circuit board 162 (or alternatively a line of interconnected boards), and LEDs 163. An end flange 164 at each end (or in other embodiments at one end only) has a pair of electrical contacts 165. An end cap 166 at each end received electrical supply wires 167, connected to a pair of annular contacts on the inner face of the end cap 166. By engaging the end cap 166 with the flange 165 immediate electrical connection is made irrespective of the extent of rotation of the end cap to tighten it. Also, each end cap incorporates a mounting bracket of the type described for the other embodiments, except that in this embodiment they have a through hole to receive the wires 167. Thus, the luminaire may be installed and removed in a simple manner without need to connect and disconnect wires. Also, the end caps combine the functions of supporting the luminaire by virtue of its mounting bracket, providing power, and providing the function of an end cap.

It will be appreciated that the invention provides a luminaire which provides substantially uniform illumination across a target plane in a display cabinet, even though there are space restrictions. Also, it achieves this even where the display cabinet has legacy lighting such as fluorescent lamps.

The invention is not limited to the embodiments described but may be varied in construction and detail.

1-32. (canceled)

33. A display case luminaire comprising:
a linear housing,
an array of LED light sources, and
a lens,
wherein the lens has non-uniform optical characteristics in cross-section, with at least two different focal lengths to provide a substantially uniform spread of light across a target plane even if the luminaire is located to emit light generally at an acute angle to the plane.

34. The display case luminaire as claimed in claim 33, wherein the lens has optical characteristics which vary continuously across the cross-section of the lens.

35. The display case luminaire as claimed in claim 33, wherein the lens has one or more discrete optical characteristic discontinuities.

36. The display case luminaire as claimed in claim 33, wherein the lens is a Fresnel lens.

37. The display case luminaire as claimed in claim 33, wherein the linear housing comprises a visor.

38. The display case luminaire as claimed in claim 37, wherein the visor extends along the length of the linear housing.

39. The display case luminaire as claimed in claim 33, further comprising a reflective surface externally of the lens and a reflective surface between the lens and the light source.

40. The display case luminaire as claimed in claim 33, wherein said external surface is a surface of the visor.

41. The display case luminaire as claimed in claim 33, wherein the housing is configured for mounting back-to-back with another similar luminaire to provide a field of emission in the range of 150° to 180°.

42. The display case luminaire as claimed in claim 33, wherein the housing is configured for mounting back-to-back with another similar luminaire to provide a field of emission in the range of 150° to 180°; and wherein the housing is generally quadrant-shaped in cross-section.

43. The display case luminaire as claimed in claim 33, wherein the lens is tilted with respect to the light source.

44. The display case luminaire as claimed in claim 33, wherein the lens is tilted with respect to the light source; and wherein the tilt angle is in the range of 10° to 15°.

45. The display case luminaire as claimed in claim 33, wherein there are a plurality of elongate lenses interconnected by connectors.

46. The display case luminaire as claimed in claim 33, wherein there are a plurality of elongate lenses interconnected by connectors; and wherein each connector is substantially H-shaped, having sockets for receiving the edges of lenses on each side.

47. The display case luminaire as claimed in claim 33, wherein the housing comprises an end cap which is removable.

48. The display case luminaire as claimed in claim 33, wherein the housing comprises an end cap which is removable; and wherein the end cap comprises a mounting bracket having a throughhole for receiving a fastener securing the luminaire to a display case.

49. The display case luminaire as claimed in claim 33, wherein the housing comprises an end cap which is removable; and wherein the end cap comprises a mounting bracket having a throughhole for receiving a fastener securing the luminaire to a display case; and wherein the mounting bracket is in the form of a U-shaped support post having a folded-over key for engaging a fixed part of the end cap.

50. The display case luminaire as claimed in claim 33, further comprising a clip-on mounting bracket having a pair of clip members for gripping opposed rear surfaces of the housing at any desired location along the housing length, the bracket having a through-hole for a fastener.

51. The display case luminaire as claimed in claim 33, wherein the luminaire further comprises a thermally insulating member over at least part of the housing.

52. The display case luminaire as claimed in claim 33, wherein the luminaire further comprises a thermally insulating member over at least part of the housing; and wherein the member is in the shape of a strip, and is secured to the luminaire housing along an edge of the housing.

53. The display case luminaire as claimed in claim 33, wherein the luminaire further comprises a thermally insulating member over at least part of the housing; and wherein said member has an outer coating presenting a metallic appearance on the outside.

54. The display case luminaire as claimed in claim 33, wherein the housing comprises an end cap which is removable; and wherein the end cap comprises an electrical connector for connecting electrical leads to the circuit.

55. The display case luminaire as claimed in claim 33, wherein the housing comprises an end cap which is removable; and wherein the end cap comprises an electrical connector for connecting electrical leads to the circuit; and wherein the connector is a slip ring connector, the connection being maintained as the end cap is rotated to be secured in place on the housing.

56. The display case luminaire as claimed in claim 33, wherein the housing comprises an end cap which is removable; and wherein the end cap comprises an electrical connector for connecting electrical leads to the circuit; and wherein the connector is an axial connector, the connection being made as the end cap is pushed towards the housing.

57. A display case luminaire assembly comprising a pair of luminaries of claim 33 secured together in a back-to-back arrangement.

58. The assembly as claimed in claim 57, wherein the luminaries are secured together by at least one plate extending across the ends of the luminaries.

59. A display case comprising:
a frame,
display shelves, and
at least one luminaire secured to the frame or a shelf,
wherein said at least one luminaire comprises:
a linear housing,
an array of LED light sources, and
a lens,
wherein the lens has non-uniform optical characteristics in cross-section, with at least two different focal lengths to provide a substantially uniform spread of light across a target plane even if the luminaire is located to emit light generally at an acute angle to the plane

60. The display case as claimed in claim 59, wherein the luminaire is vertically aligned.

61. The display case as claimed in claim 59, wherein the luminaire is horizontally aligned under a shelf.

62. The display case as claimed in claim 59, wherein the display case comprises end mullions, a luminaire on each end mullion, the luminaires being orientated for substantially uniform illuminating of a vertical plane including front edges of the display shelves.

63. The display case as claimed in claim 59, wherein the display case comprises end mullions, a luminaire on each end mullion, the luminaires being orientated for substantially uniform illuminating of a vertical plane including front edges of the display shelves; and wherein the case comprises a centre mullion and a pair of luminaires arranged back-to-back and secured to the centre mullion to provide a combined field of illumination in the range of 150° to 180° towards a vertical plane.
